(19) United States
(12) Patent Application Publication
(10) Pub. No.: US 2024/0202394 A1
(43) Pub. Date: Jun. 20, 2024

(54) METHOD FOR DYNAMIC OUTPUT FORCE DISTRIBUTION OF MULTI-DEGREE-OF-FREEDOM OVER-ACTUATED MOTION STAGE

(71) Applicant: Harbin Institute of Technology, Harbin (CN)

(72) Inventors: Yang LIU, Harbin (CN); Zhenyu CHEN, Harbin (CN); Fazhi SONG, Harbin (CN); Jiubin TAN, Harbin (CN)

(73) Assignee: Harbin Institute of Technology, Harbin (CN)

(21) Appl. No.: 18/450,421

(22) Filed: Aug. 16, 2023

(30) Foreign Application Priority Data
Dec. 8, 2022 (CN) 202211575174.1

(51) Int. Cl. G06F 30/20

(52) U.S. Cl. CPC G06F 30/20; G06F 2111/10

(57) ABSTRACT

A method for dynamic output force distribution of a multi-degree-of-freedom over-actuated motion stage includes: establishing a mathematical model G(s) of a motion stage based on a modal representation; setting a time delay interval parameter Δτ and an instruction shaper order n_{CS}, and calculating each pulse time delay parameter τᵢ; calculating matrices T_{b} and V_{b}; initializing q=1; defining H^{q}; calculating intermediate variable \tilde{T}ⱼ^{q}, \tilde{V}, Φ_{H}^{q}, Y_{H}^{q}, T_{Φ}_{_{H}}^{q}, V_{Φ}_{_{H}}^{q}, and β^{q}; calculating an estimated value Ĥ^{q} of H^{q}; obtaining an amplitude Aᵢ^{kq} of an instruction shaper; q=q+1, until calculation is completed for all logical axis channels; calculating α(s) by using Aᵢ^{kq}; and obtaining a dynamic output force distribution matrix T_{f}(s). Zero-residue vibration suppression in all controllable flexible modalities can be realized with finite actuator redundancies.

### CROSS-REFERENCE TO RELATED APPLICATIONS

This application claims priority to Chinese Patent Application No. 202211575174.1 with a filing date of Dec. 8, 2022. The content of the aforementioned application, including any intervening amendments thereto, is incorporated herein by reference.

### TECHNICAL FIELD

The present disclosure relates to a method for dynamic output force distribution of a motion stage, and in particular, to a method for dynamic output force distribution of a multi-degree-of-freedom over-actuated motion stage, and belongs to the technical field of vibration suppression for semiconductor manufacturing equipment and motion stages.

### BACKGROUND

A multi-degree-of-freedom precision motion stage is an important component in semiconductor manufacturing equipment. The performance and accuracy of motion thereof have a direct influence on a yield of the equipment and the quality of products. Thus, the multi-degree-of-freedom precision motion stage is required to realize high-accuracy control when performing high dynamic motion. The multi-degree-of-freedom motion stage is designed with a larger size to further improve the yield of the equipment. A future motion stage will be designed and developed to be lightweight and flexible due to the limitation of finite output force from an actuator and a high acceleration requirement. Thus more flexible modal vibration will be introduced to the motion system. Therefore, an over-actuation strategy may be developed by increasing the number of actuators for solving this problem. However, the introduction of an over-actuator results in a problem of non-unique solutions to a non-square actuator output force distribution matrix. Meanwhile, restrained by a finite space and quality, it is difficult to realize zero-residue vibration suppression in all controllable flexible modalities with finite actuator redundancies.

Chinese patent publication No. CN107783378B filed on Aug. 30, 2016 discloses a vertical micromotion structure of a lithography machine and a control method, in which flexible modal shape parameters of some orders are introduced into an output force distribution matrix according to the number of actuator redundancies so that vibration suppression can be realized for the flexible modalities of respective orders. However, the method cannot meet the requirement of vibration suppression for all controllable flexible modalities under finite actuator redundancies and may even enlarge the flexible modal vibration of an uncontrolled order. In view of this, it is urgent to propose a suitable actuator output force distribution matrix.

### SUMMARY OF PRESENT INVENTION

Aiming at the defects in the prior art, an objective of the present disclosure is to provide a method for dynamic output force distribution of a multi-degree-of-freedom over-actuated motion stage that can realize zero-residue vibration suppression in all controllable flexible modalities with finite actuator redundancies and is conducive to improving the distribution efficiency.

To achieve the above objective, the present disclosure adopts the following technical solution. A method for dynamic output force distribution of a multi-degree-of-freedom over-actuated motion stage includes the following steps:
Step 1: establishing a mathematical model G(s) of a motion stage based on a modal representation in accordance with a mechanical structure of the multi-degree-of-freedom over-actuated motion stage and a model identification result thereof:

$$G ( s ) = [ \begin{matrix}{C}_{1} & {C}_{2}\end{matrix} ] [ \begin{matrix}{Φ}_{1} ( s ) & \\ & {Φ}_{2} ( s )\end{matrix} ] [ \begin{matrix}{B}_{1} \\ {B}_{2}\end{matrix} ] \qquad ( 1 )$$

$${Φ}_{1} ( s ) = [ \begin{matrix}\frac{1}{{m}_{1} {s}^{2}} & & \\ & ⋱ & \\ & & \frac{1}{{m}_{{n}_{R}} {s}^{2}}\end{matrix} ] \\ {Φ}_{2} ( s ) = [ \begin{matrix}\frac{1}{{s}^{2} + 2 {ξ}_{1} {ω}_{1} s + {ω}_{1}^{2}} & & \\ & ⋱ & \\ & & \frac{1}{{s}^{2} + 2 {ξ}_{{n}_{L}} {ω}_{{n}_{L}} s + {ω}_{{n}_{L}}^{2}}\end{matrix} ] \qquad ( 2 )$$

where B₁ is a rigid modal input coupling matrix, and B₂ is a flexible modal input coupling matrix; C₁ a rigid modal output coupling matrix, and C₂ is a flexible modal output coupling matrix; m_{q} is a rigid modal quality parameter, and q is a serial number of a logical axis channel and q=1, 2, . . . , n_{R}; n_{R} is the number of rigid modalities, which is equal to a total number of logical axis channels; n_{L} is the number of flexible modalities; ξⱼ is flexible modal damping; and ωⱼ is a flexible modal frequency parameter, with a flexible modal order j=1, 2, . . . , n_{L};
Step 2: setting a time delay interval parameter Δ_{τ} and an instruction shaper order n_{CS}, and calculating each pulse time delay parameter τᵢ=Δτ·(i−1) with an instruction shaper order i=1, 2, . . . , n_{CS};
Step 3: calculating matrices T_{b} and V_{b}:

$$\{ \begin{matrix}{T}_{b} = {{B}_{1}^{T} ( {B}_{1} {B}_{1}^{T} )}^{- 1} \\ {V}_{b} = ker ( {B}_{1} )\end{matrix} ; \qquad ( 3 )$$

Step 4: initializing the serial number of a logical axis channel to q=1;
Step 5: defining a parameter vector H^{q} to be optimized in a qth column in α(s):

H^{q}=[Aₗ^{lq} . . . Aₙ_{_{CS}}^{lq} . . . Aₗⁿ^{_{V}}^{q} . . . Aₙ_{_{CS}}ⁿ^{_{V}}^{q}]^{T} (4)
where Aᵢ^{kq} is an amplitude of an instruction shaper that has a serial number q of a logical axis channel, a serial number k of a redundancy, and the instruction shaper order of i; the serial number k of the redundancy is k=1, 2, . . . , n_{V}; n_{V} is a redundancy of a motion stage actuator, n_{V}=n_{A}−n_{R}; and n_{A} is the number of motion stage actuators;
Step 6: optimizing an optimization indicator

$${min}_{{β}^{q}} {J}^{q} = {‖ {Φ}_{0} \cdot ( {T}_{M}^{q} + {V}_{M}^{q} \cdot {β}^{q} ) ‖}_{2}^{2}$$

by using a method of least squares to calculate a parameter vector β^{q} in Ĥ^{q}:

β^{q}=(V_{M}^{qT}Φ₀^{T}Φ₀V_{M}^{q})⁻¹(V_{M}^{qT}Φ₀^{T}Φ₀T_{M}^{q}) (5)

where

$${Φ}_{0} = [ \begin{matrix}1 / {ω}_{1}^{2} & & \\ & ⋱ & \\ & & 1 / {ω}_{{n}_{L}}^{2}\end{matrix} ] \\ {T}_{M}^{q} = [ \begin{matrix}{\tilde{T}}_{1}^{q} + {\tilde{V}}_{V 1} \cdot {T}_{{Φ}_{H}}^{q} \cdot {Y}_{H}^{q} \\ ⋮ \\ {\tilde{T}}_{{n}_{L}}^{q} + {\tilde{V}}_{{Vn}_{L}} \cdot {T}_{{Φ}_{H}}^{q} \cdot {Y}_{H}^{q}\end{matrix} ] \qquad ( 6 )$$

$${V}_{M}^{q} = [ \begin{matrix}{\tilde{V}}_{V 1} \cdot {V}_{{Φ}_{H}}^{q} \\ ⋮ \\ {\tilde{V}}_{{Vn}_{L}} \cdot {V}_{{Φ}_{H}}^{q}\end{matrix} ] \\ {\tilde{V}}_{Vj} = [ \begin{matrix}{\underbrace{{\tilde{V}}_{j 1} , …}}_{{n}_{CS}} & {\underbrace{{\tilde{V}}_{j 2} , …}}_{{n}_{CS}} & … & {\underbrace{{\tilde{V}}_{{jn}_{V}} , …}}_{{n}_{CS}}\end{matrix} ] \\ \{ \begin{matrix}{T}_{{Φ}_{H}}^{q} = {{Φ}_{H}^{qT} ( {Φ}_{H}^{q} \cdot {Φ}_{H}^{qT} )}^{- 1} \\ {V}_{{Φ}_{H}}^{q} = ker ( {Φ}_{H}^{q} )\end{matrix} \qquad ( 7 )$$

$${Φ}_{H}^{q} = [ \begin{matrix}{φ}_{111}^{C} & … & {φ}_{{n}_{CS} 11}^{C} & … & {φ}_{11 {n}_{V}}^{C} & … & {φ}_{{n}_{CS} 1 {n}_{V}}^{C} \\ ⋮ & & ⋮ & & ⋮ & & ⋮ \\ {φ}_{1 {n}_{L} 1}^{C} & … & {φ}_{{n}_{CS} {n}_{L} 1}^{C} & … & {φ}_{1 {n}_{L} {n}_{V}}^{C} & … & {φ}_{{n}_{CS} {n}_{L} {n}_{V}}^{C} \\ {φ}_{111}^{S} & … & {φ}_{{n}_{CS} 11}^{S} & … & {φ}_{11 {n}_{V}}^{S} & … & {φ}_{{n}_{CS} 1 {n}_{V}}^{S} \\ ⋮ & & ⋮ & & ⋮ & & ⋮ \\ {φ}_{1 {n}_{L} 1}^{S} & … & {φ}_{{n}_{CS} {n}_{L} 1}^{S} & … & {φ}_{1 {n}_{L} {n}_{V}}^{S} & … & {φ}_{{n}_{CS} {n}_{L} {n}_{V}}^{S}\end{matrix} ] \qquad ( 8 )$$

$$\{ \begin{matrix}{φ}_{ijk}^{C} = {\tilde{V}}_{jk} \cdot {e}^{{ξ}_{j} {ω}_{j} {τ}_{i}} cos ( {ω}_{dj} \cdot {τ}_{i} ) \\ {φ}_{ijk}^{S} = {\tilde{V}}_{jk} \cdot {e}^{{ξ}_{j} {ω}_{j} {τ}_{i}} sin ( {ω}_{dj} \cdot {τ}_{i} ) \\ {ω}_{dj} = {ω}_{j} \sqrt{1 - {ξ}_{j}^{2}}\end{matrix} \qquad ( 9 )$$

$${Y}_{H}^{q} = {[ \begin{matrix}- {\tilde{T}}_{1}^{q} & … & - {\tilde{T}}_{j}^{q} & … & - {\tilde{T}}_{{n}_{L}}^{q} & 0 & … & 0\end{matrix} ]}^{T} \qquad ( 10 )$$

\tilde{T}ⱼ^{q}=bⱼT_{b}^{q}, T_{b}^{q} is a qth column of T_{b}, and bⱼ is a jth column of B₂; \tilde{V}ⱼ=bⱼV_{b}; \tilde{V}ⱼₖ is a kth element of \tilde{V}ⱼ;
Step 7: calculating an estimated value Ĥ^{q} of H^{q}:

Ĥ^{q}=T_{Φ}_{_{H}}^{q} Y_{H}^{q}+V_{Φ}_{_{H}}^{q}·β^{q}·Y_{H}^{q} (11);
Step 8: correspondingly obtaining the amplitude Aᵢ^{kq} of the instruction shaper according to H^{q} defined in step 5 and Ĥ^{q} defined in step 7;
Step 9: letting q=q+1, determining whether q is greater than the total number of the logical axis channels; if yes, proceeding to step 10; and if no, skipping to step 5;
Step 10: calculating α(s) by using Aᵢ^{kq}:

$$α ( s ) = [ \begin{matrix}{\sum }_{i = 1}^{{n}_{CS}} {A}_{i}^{11} {e}^{- {τ}_{i} s} & {\sum }_{i = 1}^{{n}_{CS}} {A}_{i}^{12} {e}^{- {τ}_{i} s} & … & {\sum }_{i = 1}^{{n}_{CS}} {A}_{i}^{1 {n}_{R}} {e}^{- {τ}_{i} s} \\ ⋮ & ⋮ & ⋱ & ⋮ \\ {\sum }_{i = 1}^{{n}_{CS}} {A}_{i}^{{n}_{V} 1} {e}^{- {τ}_{i} s} & {\sum }_{i = 1}^{{n}_{CS}} {A}_{i}^{{n}_{V} 2} {e}^{- {τ}_{i} s} & … & {\sum }_{i = 1}^{{n}_{CS}} {A}_{i}^{{n}_{V} {n}_{R}} {e}^{- {τ}_{i} s}\end{matrix} ] ; \qquad ( 12 )$$

Step 11: obtaining the dynamic output force distribution matrix T (s):

T_{f}(s)=T_{b}+V_{b}·α(s) (13).

Compared with the prior art, the present disclosure achieves the following beneficial effects. The present disclosure can solve the problem of non-unique solutions to a non-square output force distribution matrix in an existing multi-degree-of-freedom over-actuation design. The dynamic output force distribution matrix is adopted so that zero-residue vibration suppression in all controllable flexible modalities can be realized with finite actuator redundancies. All calculation is explicit calculation without a numerical optimization process, leading to low time consumption in calculation. The method is conducive to improve the distribution efficiency.

### BRIEF DESCRIPTION OF THE DRAWINGS

FIG. 1 is a block diagram showing a control system for a conventional multi-degree-of-freedom over-actuated motion stage.

### DETAILED DESCRIPTION OF THE EMBODIMENTS

The technical solution of the present disclosure will be clearly and completely described below with reference to the accompanying drawings in the embodiments of the present disclosure. Apparently, the described embodiments are merely a part rather than all of the embodiments of the present disclosure. All other embodiments derived from the embodiments in the present disclosure by a person of ordinary skill in the art without creative efforts should fall within the protection scope of the present disclosure.

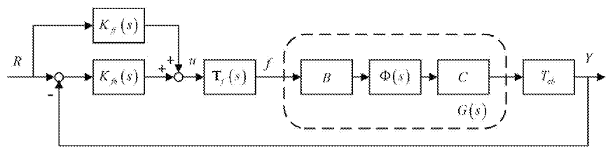

FIG. 1 is a block diagram showing a control system for a conventional multi-degree-of-freedom over-actuated motion stage. As shown, R is a reference trajectory input of the system, and Y is a tracking trajectory output of the system. u is a logical axis control quantity. f is an actuator control quantity. K_{ff}(s) is a feedback controller, and K_{fb}(s) is a feedback controller. T_{f}(s) is an actuator output force distribution matrix, and T_{cb} is a sensor decoupling matrix. G(s) is a controlled object. B is an input coupling matrix, and C is an output coupling matrix. Φ(s) is a modal dynamic matrix.

An objective of the present embodiment is to design an actuator output force distribution matrix T_{f}(s) from u to f, and T_{f}(s) is a dynamic output force distribution matrix. T_{f}(s)=T_{b}+V_{b}·α(s), with α(s) being a dynamic matrix to be designed. Thus, a method for dynamic output force distribution of a multi-degree-of-freedom over-actuated motion stage is provided, including the following steps:
Step 1: establish a mathematical model G(s) of a motion stage based on a modal representation in accordance with a mechanical structure of the multi-degree-of-freedom over-actuated motion stage and a model identification result thereof:

$$G ( s ) = [ \begin{matrix}{C}_{1} & {C}_{2}\end{matrix} ] [ \begin{matrix}{Φ}_{1} ( s ) & \\ & {Φ}_{2} ( s )\end{matrix} ] [ \begin{matrix}{B}_{1} \\ {B}_{2}\end{matrix} ] \qquad ( 1 )$$

$${Φ}_{1} ( s ) = [ \begin{matrix}\frac{1}{{m}_{1} {s}^{2}} & & \\ & ⋱ & \\ & & \frac{1}{{m}_{{n}_{R}} {s}^{2}}\end{matrix} ] \\ {Φ}_{2} ( s ) = [ \begin{matrix}\frac{1}{{s}^{2} + 2 {ξ}_{1} {ω}_{1} s + {ω}_{1}^{2}} & & \\ & ⋱ & \\ & & \frac{1}{{s}^{2} + 2 {ξ}_{{n}_{L}} {ω}_{{n}_{L}} s + {ω}_{{n}_{L}}^{2}}\end{matrix} ] \qquad ( 2 )$$

where B₁ is a rigid modal input coupling matrix, and B₂ is a flexible modal input coupling matrix; C₁ a rigid modal output coupling matrix, and C₂ is a flexible modal output coupling matrix; m_{q} is a rigid modal quality parameter, where q is a serial number of a logical axis channel and q=1, 2, . . . , n_{R}; n_{R} is the number of rigid modalities, which is equal to a total number of logical axis channels, and n_{L} is the number of flexible modalities; ξⱼ is flexible modal damping, and ωⱼ is a flexible modal frequency parameter, with a flexible modal order j=1, 2, . . . , n_{L};
Step 2: set a time delay interval parameter Δτ and an instruction shaper order n_{CS}, and calculate each pulse time delay parameter τᵢ=Δτ·(i−1) with an instruction shaper order i=1, 2, . . . , n_{CS};
Step 3: calculate matrices T_{b} and V_{b} according to the following formulas to enable that a dynamic output force distribution matrix T_{f}(s) is capable of guaranteeing that the rigid modalities are completely decoupled while suppressing flexible modal vibration:

$$\{ \begin{matrix}{T}_{b} = {{B}_{1}^{T} ( {B}_{1} {B}_{1}^{T} )}^{- 1} \\ {V}_{b} = ker ( {B}_{1} )\end{matrix} ; \qquad ( 3 )$$

Step 4: initialize the serial number of a logical axis channel to q=1;
Step 5: define a parameter vector H^{q} to be optimized in a qth column in α(s):

H^{q}=Aₗ^{lq} . . . Aₙ_{_{CS}}^{lq} . . . Aₗⁿ^{_{V}}^{q} . . . Aₙ_{_{CS}}ⁿ^{_{V}}^{q} (4)
where Aₗ^{kq} is an amplitude of an instruction shaper that has a serial number q of a logical axis channel, a serial number k of a redundancy, and the instruction shaper order of i; the serial number k of the redundancy is k=1, 2, . . . , n_{V}; n_{V} is a redundancy of a motion stage actuator, n_{V}=N_{A}−N_{R}, and n_{A} is the number of motion stage actuators;
Step 6: optimize an optimization indicator

$${min}_{{β}^{q}} {J}^{q} = {‖ {Φ}_{0} \cdot ( {T}_{M}^{q} + {V}_{M}^{q} \cdot {β}^{q} ) ‖}_{2}^{2}$$

by using a method of least squares to calculate a parameter vector β^{q} in Ĥ^{q}:

β^{q}=(V_{M}^{qT}Φ₀^{T}Φ₀V_{M}^{q})⁻¹(V_{M}^{qT}Φ₀^{T}Φ₀T_{M}^{q}) (5)

where

$${Φ}_{0} = [ \begin{matrix}1 / {ω}_{1}^{2} & & \\ & ⋱ & \\ & & 1 / {ω}_{{n}_{L}}^{2}\end{matrix} ] \\ {T}_{M}^{q} = [ \begin{matrix}{\tilde{T}}_{1}^{q} + {\tilde{V}}_{V 1} \cdot {T}_{{Φ}_{H}}^{q} \cdot {Y}_{H}^{q} \\ ⋮ \\ {\tilde{T}}_{{n}_{L}}^{q} + {\tilde{V}}_{{Vn}_{L}} \cdot {T}_{{Φ}_{H}}^{q} \cdot {Y}_{H}^{q}\end{matrix} ] \\ {V}_{M}^{q} = [ \begin{matrix}{\tilde{V}}_{V 1} \cdot {V}_{{Φ}_{H}}^{q} \\ ⋮ \\ {\tilde{V}}_{{Vn}_{L}} \cdot {V}_{{Φ}_{H}}^{q}\end{matrix} ] \\ {\tilde{V}}_{Vj} = [ \begin{matrix}{\underbrace{{\tilde{V}}_{j 1} , …}}_{{n}_{CS}} & {\underbrace{{\tilde{V}}_{j 2} , …}}_{{n}_{CS}} & … & {\underbrace{{\tilde{V}}_{{jn}_{V}} , …}}_{{n}_{CS}}\end{matrix} ] \qquad ( 6 )$$

$$\{ \begin{matrix}{T}_{{Φ}_{H}}^{q} = {{Φ}_{H}^{qT} ( {Φ}_{H}^{q} \cdot {Φ}_{H}^{qT} )}^{- 1} \\ {V}_{{Φ}_{H}}^{q} = ker ( {Φ}_{H}^{q} )\end{matrix} \qquad ( 7 )$$

$${Φ}_{H}^{q} = [ \begin{matrix}{φ}_{111}^{C} & … & {φ}_{{n}_{CS} 11}^{C} & … & {φ}_{11 {n}_{V}}^{C} & … & {φ}_{{n}_{CS} 1 {n}_{V}}^{C} \\ ⋮ & & ⋮ & & ⋮ & & ⋮ \\ {φ}_{1 {n}_{L} 1}^{C} & … & {φ}_{{n}_{CS} {n}_{L} 1}^{C} & … & {φ}_{1 {n}_{L} {n}_{1}}^{C} & … & {φ}_{{n}_{CS} {n}_{L} {n}_{V}}^{C} \\ {φ}_{111}^{S} & … & {φ}_{{n}_{CS} 11}^{S} & … & {φ}_{11 {n}_{V}}^{S} & … & {φ}_{{n}_{CS} 1 {n}_{V}}^{S} \\ ⋮ & & ⋮ & & ⋮ & & ⋮ \\ {φ}_{1 {n}_{L} 1}^{S} & … & {φ}_{{n}_{CS} {n}_{L} 1}^{S} & … & {φ}_{1 {n}_{L} {n}_{V}}^{S} & … & {φ}_{{n}_{CS} {n}_{L} {n}_{V}}^{S}\end{matrix} ] \qquad ( 8 )$$

$$\{ \begin{matrix}{φ}_{ijk}^{C} = {\tilde{V}}_{jk} \cdot {e}^{{ξ}_{j} {ω}_{j} {τ}_{i}} cos ( {ω}_{dj} \cdot {τ}_{i} ) \\ {φ}_{ijk}^{S} = {\tilde{V}}_{jk} \cdot {e}^{{ξ}_{j} {ω}_{j} {τ}_{i}} sin ( {ω}_{dj} \cdot {τ}_{i} ) \\ {ω}_{dj} = {ω}_{j} \sqrt{1 - {ξ}_{j}^{2}}\end{matrix} \qquad ( 9 )$$

$${Y}_{H}^{q} = {[ \begin{matrix}- {\tilde{T}}_{1}^{q} & … & - {\tilde{T}}_{j}^{q} & … & - {\tilde{T}}_{{n}_{L}}^{q} & 0 & … & 0\end{matrix} ]}^{T} \qquad ( 10 )$$

\tilde{T}ⱼ^{q}; =bⱼT_{b}^{q}, T_{b}^{q} is a qth column of T_{b}, and bⱼ is a jth column of B₂; \tilde{V}ⱼ=bⱼV_{b}, \tilde{V}ⱼₖ is a kth element of
Step 7: calculate an estimated value Ĥ^{q} of H^{q} in order to obtain zero-residue vibration of the flexible modalities:

\tilde{H}_{q}=T_{Φ}_{_{H}}^{q}·Y_{H}^{q}+V_{Φ}_{_{H}}^{q}·β^{q}·Y_{H}^{q} (11);
Step 8: correspondingly obtain the amplitude Aᵢ^{kq} of the instruction shaper according to H^{q} defined in step 5 and Ĥ^{q} defined in step 7;
Step 9: q=q+1, determine whether q is greater than the total number of the logical axis channels; if yes, proceed to step 10; and if no, skip to step 5;
Step 10: calculate α(s) by using Aᵢ^{kq}

$$α ( s ) = [ \begin{matrix}{\sum }_{i = 1}^{{n}_{CS}} {A}_{i}^{11} {e}^{- {τ}_{i} s} & {\sum }_{i = 1}^{{n}_{CS}} {A}_{i}^{12} {e}^{- {τ}_{i} s} & … & {\sum }_{i = 1}^{{n}_{CS}} {A}_{i}^{1 {n}_{R}} {e}^{- {τ}_{i} s} \\ ⋮ & ⋮ & ⋱ & ⋮ \\ {\sum }_{i = 1}^{{n}_{CS}} {A}_{i}^{{n}_{V} 1} {e}^{- {τ}_{i} s} & {\sum }_{i = 1}^{{n}_{CS}} {A}_{i}^{{n}_{V} 2} {e}^{- {τ}_{i} s} & … & {\sum }_{i = 1}^{{n}_{CS}} {A}_{i}^{{n}_{V} {n}_{R}} {e}^{- {τ}_{i} s}\end{matrix} ] \qquad ( 12 )$$

Step 11: obtain the dynamic output force distribution matrix

T_{f}(s)=T_{b}+V_{b}·α(s) (13).

The present disclosure is mainly applied to design an output force distribution matrix for a multi-degree-of-freedom over-actuated motion stage, including two parts, namely establishing a mathematical model of the over-actuated motion stage based on a modal representation and designing a dynamic output force distribution matrix based on instruction execution. The part of establishing the mathematical model of the over-actuated motion stage based on the modal representation needs to obtain parameters of the mathematical model of the motion stage based on the modal representation in accordance with a mechanical structure of the motion stage and a model identification result thereof. The part of designing the dynamic output force distribution matrix based on the instruction execution is to design a dynamic matrix of output force distribution with the instruction shaping idea and obtain an analytical solution to a non-square output force distribution matrix. Zero-residue vibration suppression in all controllable flexible modalities can be realized. Overall implementation of the present disclosure is simpler and more convenient.

It is apparent for those skilled in the art that the present disclosure is not limited to details of the above exemplary embodiments. The present disclosure may be implemented in other particular forms without departing from the spirit or essential features of the present disclosure. The embodiments should be regarded as exemplary and non-limiting in every respect. The protection scope of the present disclosure is defined by the appended claims rather than the above descriptions. Therefore, all changes falling within the meaning and scope of equivalent elements of the claims are intended to be included in the present disclosure. Any reference numeral in the claims should not be considered as limiting the claims involved.

In addition, it should be understood that although this specification is described in accordance with the implementations, not each implementation only contains an independent technical solution. The description in the specification is only for clarity. Those skilled in the art should take the specification as a whole. The technical solutions in the embodiments can also be properly combined to form other implementations that can be understood by those skilled in the art.

1. A method for dynamic output force distribution of a multi-degree-of-freedom over-actuated motion stage, wherein the multi-degree-of-freedom over-actuated motion stage is formed of a mechanical structure and is operated in a control system that is a closed-loop feedback system that receives an input of a reference trajectory input and generates a tracking trajectory output in response to the reference trajectory input to control a motion of the multi-degree-of-freedom over-actuated motion stage, the method comprising the following steps:
step 1: establishing a mathematical model G(s) of the multi-degree-of-freedom over-actuated motion stage based on a modal representation in accordance with the mechanical structure of the multi-degree-of-freedom over-actuated motion stage and a model identification result thereof:
$$G ( s ) [ \begin{matrix}C & C\end{matrix} ] [ \begin{matrix}( s ) & \\ & ( s )\end{matrix} ] [ \begin{matrix}B \\ B\end{matrix} ] \qquad ( 1 )$$
$$( s ) [ \begin{matrix}\overline{m s} & & \\ & ⋱ & \\ & & \overline{{m}_{{n}_{R}} s}\end{matrix} ] \\ s [ \begin{matrix}\overline{ξω s ω} & & \\ & ⋱ & \\ & & \overline{s {ξ}_{{n}_{L}} {ω}_{{n}_{L}} s {ω}_{{n}_{L}}}\end{matrix} ] \qquad ( 2 )$$
wherein:
B₁ is a rigid modal input coupling matrix, and B₂ is a flexible modal input coupling matrix;
C₁ a rigid modal output coupling matrix, and C₂ is a flexible modal output coupling matrix;
m_{q} is a rigid modal quality parameter, and q is a serial number of a logical axis channel and q, , . . . , N_{R};
n_{R} is a number of rigid modalities, which is equal to a total number of logical axis channels, and n_{L} is a number of flexible modalities;
ξⱼ is flexible modal damping, and ωⱼ is a flexible modal frequency parameter, with a flexible modal order j, , . . . , n_{L};
step 2: setting a time delay interval parameter Δτ and an instruction shaper order n_{CS}, and calculating each pulse time delay parameter τᵢ=Δτ(i−1) with an instruction shaper order i, , . . . , n_{CS};
step 3: calculating matrices T_{b} and V_{b}:
$$\{ \begin{matrix}{T}_{b} = {B}^{T} & {BB}^{T -} \\ {V}_{b} & B\end{matrix} \qquad ( 3 )$$
step 4: initializing the serial number of the logical axis channel to q=1;
step 5: defining a parameter vector H^{q} to be optimized in a qth column in α(s):
H^{q}[A^{q}. . . Aₙ_{_{CS}}^{q} . . . Aⁿ^{ᵥ}^{q}. . . Aₙ_{_{CS}}ⁿ^{ᵥ}^{q}] (4)
wherein Aᵢ^{kq} is an amplitude of an instruction shaper that has a serial number q of a logical axis channel, a serial number k of a redundancy, and the instruction shaper order of i; the serial number k of the redundancy is k, , . . . , nᵥ; nᵥ is a redundancy of a motion stage actuator, nᵥ=n_{A}−N_{R}, and n_{A} is the number of motion stage actuators;
step 6: optimizing an optimization indicator
$${min}_{{β}^{q}} {J}^{q} = {‖ {Φ}_{0} \cdot ( {T}_{M}^{q} + {V}_{M}^{q} \cdot {β}^{q} ) ‖}_{2}^{2}$$
by using a method of least squares to calculate a parameter vector β^{q} in Ĥ^{q}:
β^{q}(V_{M}^{qTT}V_{M}^{q})⁻(V_{M}^{qTT}V_{M}^{q}) (5)
wherein
$${Φ}_{0} = [ \begin{matrix}1 / {ω}_{1}^{2} & & \\ & ⋱ & \\ & & 1 / {ω}_{{n}_{L}}^{2}\end{matrix} ] \\ {T}_{M}^{q} = [ \begin{matrix}{\tilde{T}}_{1}^{q} + {\tilde{V}}_{V 1} \cdot {T}_{{Φ}_{H}}^{q} \cdot {Y}_{H}^{q} \\ ⋮ \\ {\tilde{T}}_{{n}_{L}}^{q} + {\tilde{V}}_{{Vn}_{L}} \cdot {T}_{{Φ}_{H}}^{q} \cdot {Y}_{H}^{q}\end{matrix} ] \\ {V}_{M}^{q} = [ \begin{matrix}{\tilde{V}}_{V 1} \cdot {V}_{{Φ}_{H}}^{q} \\ ⋮ \\ {\tilde{V}}_{{Vn}_{L}} \cdot {V}_{{Φ}_{H}}^{q}\end{matrix} ] \\ {\tilde{V}}_{Vj} = [ \begin{matrix}{\underbrace{{\tilde{V}}_{j 1} , …}}_{{n}_{CS}} & {\underbrace{{\tilde{V}}_{j 2} , …}}_{{n}_{CS}} & … & {\underbrace{{\tilde{V}}_{{jn}_{V}} , …}}_{{n}_{CS}}\end{matrix} ] \qquad ( 6 )$$
$$\{ \begin{matrix}{T}_{{Φ}_{H}}^{q} = {{Φ}_{H}^{qT} ( {Φ}_{H}^{q} \cdot {Φ}_{H}^{qT} )}^{- 1} \\ {V}_{{Φ}_{H}}^{q} = ker ( {Φ}_{H}^{q} )\end{matrix} \qquad ( 7 )$$
$${Φ}_{H}^{q} = [ \begin{matrix}{φ}_{111}^{C} & … & {φ}_{{n}_{CS} 11}^{C} & … & {φ}_{11 {n}_{V}}^{C} & … & {φ}_{{n}_{CS} 1 {n}_{V}}^{C} \\ ⋮ & & ⋮ & & ⋮ & & ⋮ \\ {φ}_{1 {n}_{L} 1}^{C} & … & {φ}_{{n}_{CS} {n}_{L} 1}^{C} & … & {φ}_{1 {n}_{L} {n}_{V}}^{C} & … & {φ}_{{n}_{CS} {n}_{L} {n}_{V}}^{C} \\ {φ}_{111}^{S} & … & {φ}_{{n}_{CS} 11}^{S} & … & {φ}_{11 {n}_{V}}^{S} & … & {φ}_{{n}_{CS} 1 {n}_{V}}^{S} \\ ⋮ & & ⋮ & & ⋮ & & ⋮ \\ {φ}_{1 {n}_{L} 1}^{S} & … & {φ}_{{n}_{CS} {n}_{L} 1}^{S} & … & {φ}_{1 {n}_{L} {n}_{V}}^{S} & … & {φ}_{{n}_{CS} {n}_{L} {n}_{V}}^{S}\end{matrix} ] \qquad ( 8 )$$
$$\{ \begin{matrix}{φ}_{ijk}^{C} = {\tilde{V}}_{jk} \cdot {e}^{{ξ}_{j} {ω}_{j} {τ}_{i}} cos ( {ω}_{dj} \cdot {τ}_{i} ) \\ {φ}_{ijk}^{S} = {\tilde{V}}_{jk} \cdot {e}^{{ξ}_{j} {ω}_{j} {τ}_{i}} sin ( {ω}_{dj} \cdot {τ}_{i} ) \\ {ω}_{dj} = {ω}_{j} \sqrt{1 - {ξ}_{j}^{2}}\end{matrix} \qquad ( 9 )$$
$${Y}_{H}^{q} = [ \begin{matrix}- {\tilde{T}}^{q} & … & - {\tilde{T}}_{j}^{q} & … & - {\tilde{T}}_{{n}_{L}}^{q} & …\end{matrix} ] \qquad ( 10 )$$
\tilde{T}ⱼ^{q} bⱼT_{b}^{q} is a qth column of T_{b}, and bⱼ is a jth column of B₂; \tilde{V}ⱼbⱼV_{b}, \tilde{V}ⱼₖ is a kth element of \tilde{V}ⱼ;
step 7: calculating an estimated value Ĥ^{q} of H^{q}:
Ĥ^{q}T^{q}_{H}·Y_{H}^{q}V^{q}_{H}·β^{q}·Y_{H}^{q} (11);
step 8: correspondingly obtaining the amplitude Aᵢ^{kq} of the instruction shaper according to H^{q} defined in step 5 and Ĥ^{q} defined in step 7;
step 9: letting q=q+1, determining whether q is greater than the total number of the logical axis channels; if yes, proceeding to step 10; and if no, skipping to step 5;
step 10: calculating α(s) by using Aᵢ^{kq}:
$$α ( s ) = [ \begin{matrix}{\sum }_{i = 1}^{{n}_{CS}} {A}_{i}^{11} {e}^{- {τ}_{i} s} & {\sum }_{i = 1}^{{n}_{CS}} {A}_{i}^{12} {e}^{- {τ}_{i} s} & … & {\sum }_{i = 1}^{{n}_{CS}} {A}_{i}^{1 {n}_{R}} {e}^{- {τ}_{i} s} \\ ⋮ & ⋮ & ⋱ & ⋮ \\ {\sum }_{i = 1}^{{n}_{CS}} {A}_{i}^{{n}_{V} 1} {e}^{- {τ}_{i} s} & {\sum }_{i = 1}^{{n}_{CS}} {A}_{i}^{{n}_{V} 2} {e}^{- {τ}_{i} s} & … & {\sum }_{i = 1}^{{n}_{CS}} {A}_{i}^{{n}_{V} {n}_{R}} {e}^{- {τ}_{i} s}\end{matrix} ] ; \qquad ( 12 )$$
step 11: obtaining a dynamic output force distribution matrix T(s):
T_{f}(s)T_{b}V_{b}·α(s) (13).
